(19) United States
(12) Patent Application Publication
(10) Pub. No.: US 2024/0430097 A1
(43) Pub. Date: Dec. 26, 2024

(54) SECURE HASHING SERVER

(71) Applicant: MICRO FOCUS LLC, SANTA CLARA, CA (US)

(72) Inventors: Douglas Max Grover, Rigby, ID (US); Michael F. Angelo, Houston, TX (US)

(21) Appl. No.: 18/214,243

(22) Filed: Jun. 26, 2023

(51) Int. Cl. H04L 9/32; H04L 9/00

(52) U.S. Cl. CPC H04L 9/3236; H04L 9/321; H04L 9/50

(57) ABSTRACT

A first hash of information is generated. The first hash of the information is used to validate if the information (e.g., a software application) has changed. The first hash of the information is generated locally. The first hash of the information is sent to the trusted authority. The trusted authority is a service that is managed by an external party. A validation event associated with the information is detected. A request for the first hash of the information is sent to the trusted authority. The first hash of the information is received from the trusted authority. A second hash of the information is generated. The second hash of the information is generated locally. The received first hash of the information is compared to the generated second hash of the information to determine if the received first hash of the information is the same as the second hash of the information.

### BACKGROUND

Traditional hashing solutions are one way to protect data. However, traditional hashing has limitations. For example, if someone knows the hashing algorithm used to generate the hash, the data may be changed, and the hash may be regenerated without someone knowing. While this is computationally difficult today, it will be trivial to do in the future. When the data is later hashed and compared to the previous hash, it can appear that the data has not been altered, even though the data actually has been altered. This is referred to as a Hash Collision.

### SUMMARY

These and other needs are addressed by the various embodiments and configurations of the present disclosure. The present disclosure can provide a number of advantages depending on the particular configuration. These and other advantages will be apparent from the disclosure contained herein.

A first hash of information is generated. The first hash of the information is used to validate if the information (e.g., a software application, configuration, or control data) has changed. The first hash of the information is generated locally. For example, the first hash is generated by a communication device or server that is external to a trusted authority. The first hash of the information is sent to the trusted authority. The trusted authority is a service that is managed by an external party. A validation event associated with the information is detected. For example, a validation event may be where the software application is requesting to be loaded. A request for the first hash of the information is sent to the trusted authority. The first hash of the information is received from the trusted authority. A second hash of the information is generated. The second hash of the information is generated locally. The received first hash of the information is compared to the generated second hash of the information to determine if the received first hash of the information is the same as the second hash of the information. The comparison is done locally.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures. materials, or acts set forth herein, and all of the equivalents thereof. Further, the structures, materials or acts and the equivalents thereof shall include all those described in the summary, brief description of the drawings, detailed description, abstract, and claims themselves.

As defined herein and in the claims, the term “local” is any location external to a trusted authority.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system of a secure hashing service.

FIG. 2 is a flow diagram of a process for determining if a hash of information is valid.

FIG. 3 is a flow diagram of a process for determining if information is valid.

FIG. 4 is a flow diagram of a process for comparing hashes locally to determine if information is valid.

FIG. 5 is a flow diagram of a process for determining if a hash of information is valid.

FIG. 6 is a flow diagram of a process for determining if information is valid.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

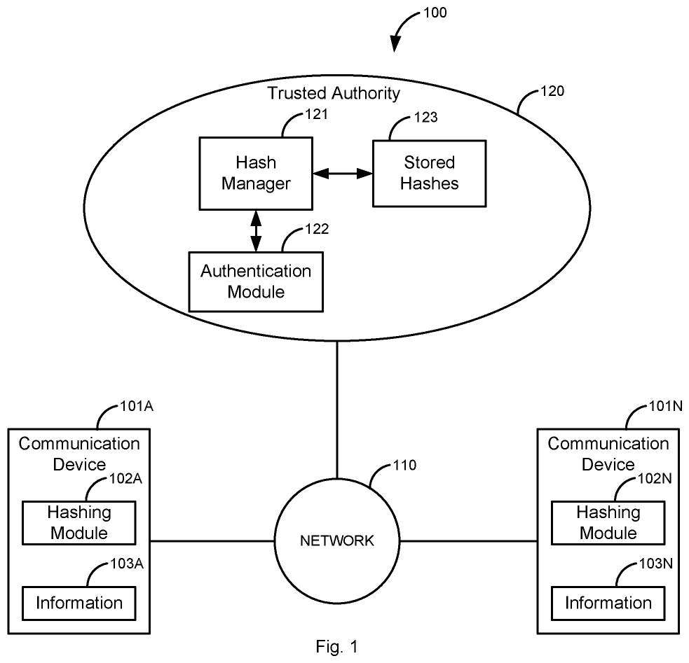

FIG. 1 is a block diagram of a first illustrative system 100 of a secure hashing service. The first illustrative system 100 comprises communication devices 101A-101N, a network 110, and a trusted authority 120.

The communication devices 101A-101N can be or may include any device that can communicate on the network 110, such as a Personal Computer (PC), a telephone, a video system, a cellular telephone, a Personal Digital Assistant (PDA), a tablet device, a notebook device, a smartphone, a server, an embedded device, and the like. As shown in FIG. 1, any number of communication devices 101A-101N may be connected to the network 110, including only a single communication device 101.

The communication devices 101A-101N further comprise hashing modules 102A-102N and information 103A-103N. The hashing modules 102A-102N can be or may include any hardware coupled with software that can generate and manage hashes/information 103A-103N.

The information 103A-103N may be any type of information 103A-103N, such as, a file(s), an application(s), a software component(s), a document(s), one or more block(s) in a blockchain, a blockchain(s), a database record(s), a database table(s), any collection of data, network traffic data, log files, and/or the like. The information 103A-103N is typically hashed by the hashing modules 102A-102N to protect against changes in the information 103A-103N.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network 110 configured to carry messages via packets and/or circuit switched communications.

The trusted authority 120 can be any hardware coupled with software that can manage hash information. The trusted authority 120 further comprises a hash manager 121, an authentication module 122, and stored hashes 123.

The hash manager 121 can be or may include any hardware/software that can manage the stored hashes 123 and compare the stored hashes 123 to new hashes of the information 103. The hash manager may also compare the information 103.

The stored hashes 123 are hashes of the information 103 that have been stored off and are used to validate that the information 103A-103N has not changed. The stored hashes may be generated using any existing hashing algorithms (or future), such as, Secure Hashing Algorithm (SHA), Message Digest (MD), and/or the like. The hashing algorithms may use different key sizes, such as 64-bit, 128-bit, 256-bit, 512-bit, 1024-bit and/or the like.

The stored hashes 123 may have additional information that is provided when the stored hashes 123 are received. For example, the hash additional identification information may include a tenant identifier, a hash Identifier (ID), authentication credential information (e.g., a user identifier, a pointer to the credential, a credential type, etc.), application information (e.g., name and version), component information (name/version), document information (name/date), blockchain information (name/date/blockchain ID, block ID), etc. The trusted authority uses this information 120 to look up the appropriate stored hash(s) 123 when verifying a received/generated hash(es).

The authentication module 122 allows a user/communication device 101 to be able to authenticate to the trusted authority 120. The authentication module 122 can use various authentication protocols, such as, a username/password, biometric(s), Short Message Service (SMS) texts, email codes, one-time-passwords, multi-factor authentication, digital certificates, and/or the like. Using the authentication module 122, a user can save the stored hash(es) 123 for later retrieval in a hash verification process.

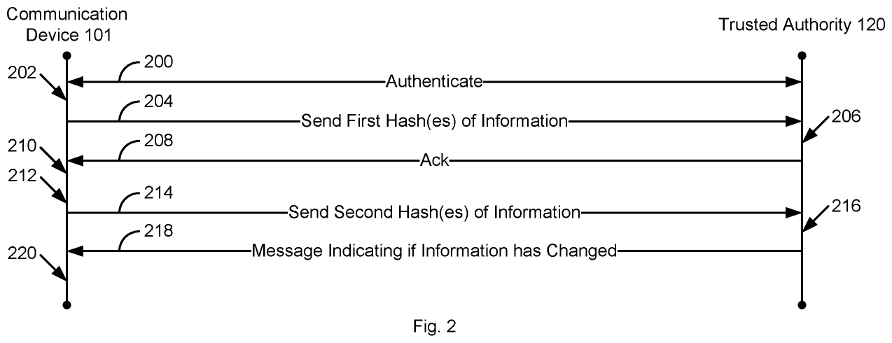

FIG. 2 is a flow diagram of a process for determining if a hash of information 103 is valid. Illustratively, the communication devices 101A-101N, the hashing modules 102A-102N, the trusted authority 120, the hash manager 121, and the authentication module 122 are stored-program-controlled entities, such as a computer or microprocessor, which performs the methods of FIGS. 2-6 and the processes described herein by executing program instructions stored in a computer readable storage medium, such as a memory (i.e., a computer memory, a hard disk, and/or the like). Although the methods described in FIGS. 2-6 are shown in a specific order, one of skill in the art would recognize that the steps in FIGS. 2-6 may be implemented in different orders and/or be implemented in a multi-threaded environment. Moreover, various steps may be omitted or added based on implementation.

The trusted authority 120 is used to create a hash registry to validate hashes of information 103 that needs to be secured. The trusted authority 120 can be used to validate any kind of hash, such as, hashes of authentication credentials (e.g., separate hashes of individual user authentication credentials), hashes of database records, a hash of a document, a hash of an application, a hash of a software/firmware component, a hash of a blockchain block(s), hash(es) of a blockchain, a file hash, a hash of a Non-Fungible Token (NFT), and/or the like. For blockchains, the blockchain may or may not have an associated distributed ledger (e.g., there may be a single blockchain that is not replicated in a distributed ledger). The hashes may comprise hashes of multiple blocks of a blockchain. For example, if an existing blockchain has ten blocks, the hashes may be individual hashes for each hash of the blocks in the blockchain as is traditionally done in blockchains.

The process starts in step 200 when the user/communication device 101 authenticates to the trusted authority 120. For example, the user may provide a username/password via the communication device 101 to authenticate to the trusted authority 120 in step 200. The communication device 101 determines, in step 202, if the hash(es) needs to be sent to the trusted authority 120. The communication device 101 may decide to send the hash(es) based on any number of reasons. For example, the communication device 101 may send the hash 101 based on the creation of a user account, based on the installation of a product/application/component, based on the creation of a blockchain, based on storing part of a blockchain, based on the receipt/storage of a document/NFT, based on archiving a file, based on an administration event, and/or the like.

The communication device 101 generates and sends, in step 204, the hash(es) of the information 103 to the trusted authority 120. The hash could be generated using a Hash Messaging Code (HMAC) where both the communication device 101 and the trusted authority 120 have the key to produce and unencrypt the hash using the HMAC.

The process of sending the hash in step 204 may be based on hashing any type of information 103. For example, as a user creates initial authentication credentials, the authentication credential(s) (e.g., the password) are hashed (e.g., doing a forward/reverse hash) and then sent to the trusted authority 120 in step 204. If the user has other authentication credential(s) they may be individually hashed and sent in step 204 in a similar manner. For example, if the user has completed an initial fingerprint scan, an initial iris scan, a facial scan, an initial voiceprint, etc., the authentication credentials are hashed and sent to the trusted authority 120. In one embodiment, in addition to the individual hashes, there could be an overall authentication hash that is sent in step 204. For example, if the user has a password, a fingerprint scan, and a voiceprint, an overall authentication hash (which is a hash of all the authentication credentials) can be sent to the trusted authority 120 in addition to the individual hashes of the authentication credentials.

If an authentication credential changes, that hash will have to be re-registered. For example, a user's password typically will change over time. On the other hand, an initial reference fingerprint scan is typically only taken once. If there is multi-factor authentication based on levels, the hashes of the authentication credentials for each authentication level may be sent to the trusted authority 120 in step 204.

In another embodiment, a company could register a hash of a product/application/component/library with the trusted authority 120. The registered hash is then used to validate if the product/application/component has been tampered with. Other examples may include backing up hashes of a blockchain. For example, as new blocks/hashes are added to a blockchain, the hashes (forward/reverse and/or any hash used in the blockchain) could be sent to the trusted authority 120 to verify that the blockchain has not been tampered with. This process could be extended to files, documents, Non-Fungible Tokens (NFTs), and/or the like for verifying if the documents/NFTs are still valid.

In addition to the hash, the message of step 204 may include additional information to be able to uniquely identify the hash. For example, hash identification information may include a tenant identifier, a hash ID, authentication credential information (e.g., a user identifier, a pointer to the credential, a credential type, etc.), application information (e.g., name and version), component information (name/version), document information (name/date), blockchain information (name/date/blockchain ID, block ID), etc.

While a single hash is described in step 204, in one embodiment, the hash may include a forward first hash of the information 103 and a first reverse hash of the information 103. Alternatively, the hash may include the first forward hash of the information 103 using a first hashing algorithm and a second forward hash of the information 103 using a second hashing algorithm (e.g., the first hash uses a Secure Hashing Algorithm (SHA) 256 and the second hash uses a Message Digest (MD) 5). In another embodiment, the hash may include a first reverse hash of the information 103 using the first hashing algorithm and a second reverse hash of the information 103 using the second hashing algorithm. By doing multiple hashes of the information 103, this protects against hash collisions. A hash collision is where the information 103 is changed but produces an identical hash. In addition, three or more different hashes of the same information 103 may be sent in step 204.

The trusted authority 120 stores the hash(es) (the stored hashes 123) in step 206. The trusted authority 120 sends, in step 208, an acknowledgement message.

A validation event associated with the information 103 is identified in step 210. The validation event could be any event that requires the hash of the information 103 to be validated. For example, if the user is authenticating, the user's authentication credentials may need to be validated (e.g., any of those described herein). Other examples of a validation event may be an event where a product/application/component/library is being loaded and verification of the product/application/component/library is needed. Likewise, a validation event may be to validate if the hashes of a blockchain are valid or to determine if a hash of a document/NFT is still valid. A validation event could be where an archived file, a document, a database record, and/or the like needs to be validated.

In response to the validation event (or perhaps it could already be generated), the hashing module 102 generates a hash of the information 103 in step 212. Step 212 may also include comparing the generated hash of step 212 to a locally stored hash of the hash sent in step 204. If the two hashes do not match, the process goes directly to step 220 because the information 103 is no longer valid. If the two hashes are valid, the process goes to step 214.

The hash of the information 103 is sent to the trusted authority 120 in step 214. The trusted authority 120 compares, in step 216, the hash received in step 204 to the second hash received in step 214. The trusted authority 120 sends, in step 218, a message indicating if the information 103 has changed. If the two hashes are the same in step 216, the message of step 218 indicates that the information 103 has not changed. Otherwise, if the two hashes are different in step 216, the message of step 218 will indicate that the hashes do not match.

While step 216 is described using a single hash, as discussed herein, multiple hashes may be validated in step 216. For example, if there is a forward/reverse hash, both hashes may be validated in step 216.

The communication device 101 determines, in step 220, how to manage the message of step 218. For example, if the hashes are valid, the user may be authenticated, a product/application/component/library may be loaded, the blockchain may be confirmed as still valid, the document/NFT may be declared as valid and/or the like.

If the message of step 218 indicates that one or more of the hash(es) are not valid (e.g., a forward hash of the information 103 is valid, but a reverse hash of the information 103 is not valid), an action may be taken. For example, the user may not be allowed to login, a product/application/component may not be loaded, a document/NFT/blockchain may be declared as being changed, a backup copy may be restored, and/or the like.

To illustrate, consider the following examples. When the user provides their username/password, the password is hashed, and the hash is then sent to the trusted authority 120 along with the information to identify the correct hash. The trusted authority 120 then validates that the current password is still valid by comparing the hashes. If someone has somehow hacked the password and changed it, the hashes will not match.

If the user tries to log in using one of the authentication credentials. The locally stored authentication credential is validated by sending the hash of the local authentication credential to the trusted authority 120 before it is compared to a live authentication credential being provided by the user.

Likewise, if an overall authentication hash is used, the overall authentication hash is compared to an overall authentication hash stored by the trusted authority 120. If the overall authentication hash fails, the user will be notified of the overall authentication hash failure and that at least one of the user's authentication credentials has been compromised. For example, if the user logins using a username/password, the hash of the password and the overall authentication hash would be sent for verification.

In one embodiment, the hash may be a hash of encrypted authentication credential(s). For example, if the username/password is encrypted, the sent hash may be a hash of the encrypted password.

If someone wanted to validate that the product/application/component/library has not been tampered with, the trusted authority 120 is used to validate the product/application/component/library. As discussed above, a forward/backward hash can be used to detect collisions. An example may be where an open-source database registers hashes of verified open-source components (e.g., based on the name/version number). When an application is being loaded, the loader can generate a hash of the application, a hash of a component, a hash of a library (e.g., any software that the application uses), etc., and then go to the trusted authority 120 and validate that the application/component/library has not been tampered with.

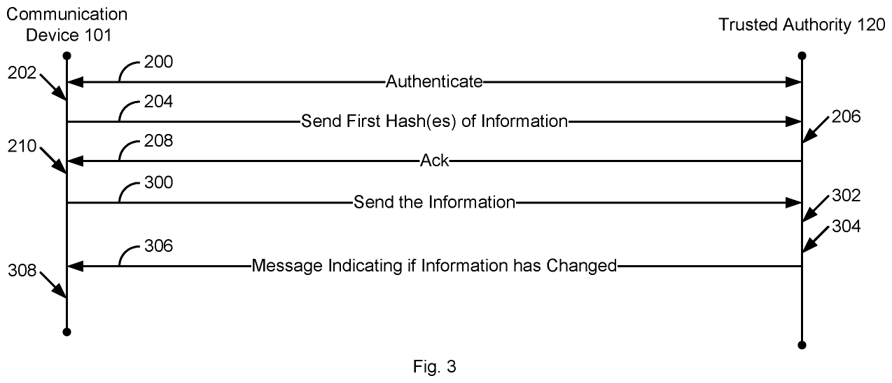

All the examples/embodiments described in FIGS. 1-2 may also be used for FIGS. 3-6. For example, the different uses of the hashes (e.g., for authentication credentials, application verification, blockchain verification, backup verification, document/NFT verification, etc. . . . ), sending multiple hashes, managing valid/invalid hashes, and/or the like can be used for the processes described in in FIGS. 3-6.

FIG. 3 is a flow diagram of a process for determining if information 103 is valid. The process starts in step 200 when the user/communication device 101 authenticates to the trusted authority 120. The communication device 101 determines, in step 202, if the hash(es) needs to be sent to the trusted authority 120. If the hash(es) need to be sent in step 204, the communication device 101 generates and sends, in step 204, the hash(es) of the information 103 to the trusted authority 120.

The trusted authority 120 stores the hash(es) (the stored hashes 123) in step 206. The trusted authority 120 sends, in step 208, an acknowledgement message.

A validation event associated with the information 103 is identified in step 210. The communication device 101, in step 300, gets the information 103. For example, the information 103 may be a software component or the authentication credential(s). The communication device 101 sends, in step 300, the information 103 to the trusted authority 120. The trusted authority 120 generates, in step 302, a hash of the information 103. The generated hash is compared, in step 304, to the stored hash of step 206.

The trusted authority 120 sends, in step 306, a message indicating if the information 103 has changed. If the two hashes are the same in step 304, the message of step 306 indicates that the hash of the information 103 has not changed. Otherwise, if the two hashes are different in step 304, the message of step 306 will indicate that the hashes do not match. The communication device 101 determines, in step 308, how to manage the message of step 306.

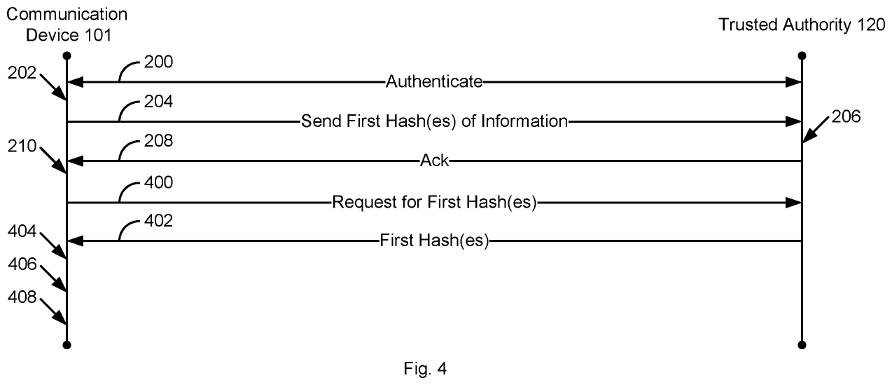

FIG. 4 is a flow diagram of a process for comparing hashes locally to determine if information 103 is valid. The process starts in step 200 when the user/communication device 101 authenticates to the trusted authority 120. The communication device 101 determines, in step 202, if the hash(es) needs to be sent to the trusted authority 120. IF the hash(es) need to be sent to the trusted authority, the communication device 101 sends, in step 204, the hash(es) of the information 103 to the trusted authority 120.

The trusted authority 120 stores the hash(es) (the stored hashes 123) in step 206. The trusted authority 120 sends, in step 208, an acknowledgement message.

A validation event associated with the information 103 is identified in step 210. The communication device 101, in step 400, sends a request for the stored hash(es) (stored in step 206) to the trusted authority 120. The trusted authority 120 sends, in step 402, the stored hash(es).

The communication device 101 generates, in step 404, the hash(es) of the information 103. The communication device 101 compares the generated hash(es) to the hash(es) received in step 402 to determine if the hash(es) match or not in step 406. Based on the comparison, the communication device 101 takes an action in step 408. For example, the communication device 101 may not load an application if the hash(es) are not the same.

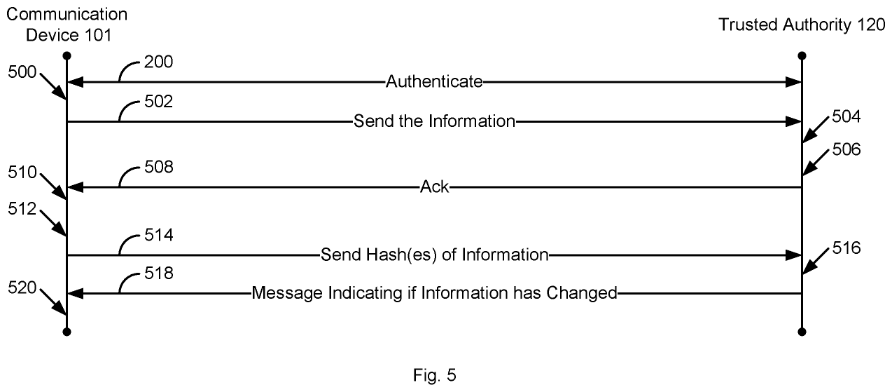

FIG. 5 is a flow diagram of a process for determining if a hash of information 103 is valid. The process starts in step 200 when the user/communication device 101 authenticates to the trusted authority 120. The communication device 101 determines, in step 500, if the information 103 needs to be sent to the trusted authority 120. If the information 103 needs to be sent to the trusted authority 120, in step 500, the communication device 101 sends, in step 502, the information 103 to the trusted authority 120. The trusted authority 120, in step 504, generates a hash(es) of the information 103. The trusted authority 120 then stores the hash(es) of the information 103 in step 506. The trusted authority 120 sends, in step 508, an acknowledgement message to the communication device 101. The communication device 101 detects a validation event in step 510. In response to the validation event, the communication device 101 generates the hash(es) of the information 103 in step 512. The communication device 101 sends, in step 514, the hash(es) of the information 103 to the trusted authority 120.

The trusted authority 120 receives the hash(es) of the information 103 of step 514 and compares, in step 516, the received hash(es) of step 514 to the stored hash(es) of step 506. The trusted authority 120 sends, in step 518, a message indicating if the information 103 has changed. If the hashes are the same in step 516, the message of step 518 indicates that the hash of the information 103 has not changed. Otherwise, if the hashes are different in step 516, the message of step 518 will indicate that the hashes do not match. The communication device 101 determines, in step 520, how to manage the message of step 518 by taking an action. For example, the communication device 101 may elect to not allow a user to authenticate.

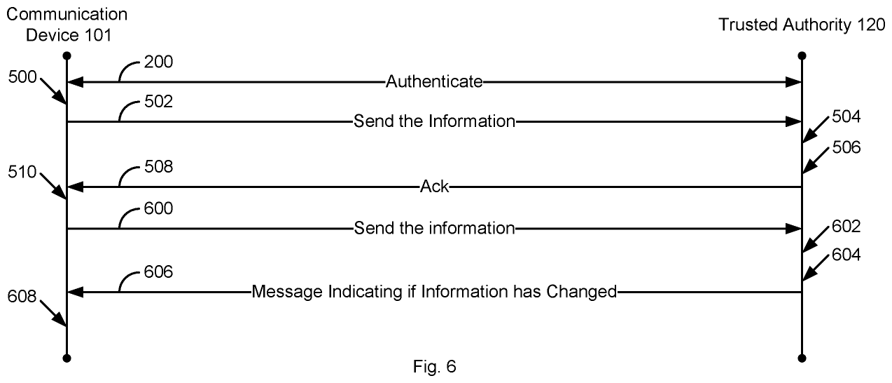

FIG. 6 is a flow diagram of a process for determining if information 103 is valid. The process starts in step 200 when the user/communication device 101 authenticates to the trusted authority 120. The communication device 101 determines, in step 500, if the information 103 needs to be sent to the trusted authority 120. If the information 103 needs to be sent to the trusted authority 120, in step 500, the communication device 101 sends, in step 502, the information 103 to the trusted authority 120. The trusted authority 120, in step 504, generates a hash(es) of the information 103 (and/or could store the information 103). The trusted authority 120 then stores the hash(es) of the information 103 in step 506 (and/or the information 103). The trusted authority 120 sends, in step 508, an acknowledgement message to the communication device 101.

The communication device 101 detects a validation event in step 510. In response to the validation event, the communication device 101 sends, in step 600, the information 103 to the trusted authority 120. The trusted authority 120, in step 602, generates the hash(es) of the information 103. The trusted authority 120 compares the generated hash(es) of step 602 to the stored hash(es) of step 506. Alternatively, instead of comparing the hashes, the trusted authority 120 can directly compare the information 103 received in step 504 to the information 103 received in step 600 (or do both).

The trusted authority 120 sends, in step 606, a message indicating if the information 103 has changed. If the two hashes/information 103 are the same in step 604, the message of step 606 indicates that the hash of the information 103 has not changed. Otherwise, if the two hashes/information 103 are different in step 604, the message of step 606 will indicate that the hashes do not match. The communication device 101 determines, in step 608, how to manage the message of step 606. For example, the communication device 101 may back up a file that appears to have been corrupted.

All the processes above could use signed credentials. This can be done where the trusted authority 120 sends a nonce, the desired hashing algorithm, encrypted with the public key of the communication device 101. The communication device 101 decrypts the nonce using the desired hashing algorithm, generates a hash using the nonce (a HMAC), then encrypts it with the public key. The trusted authority 120 receives the response and then processes it. The trusted authority 120 can then add a timestamp to indicate that the response was validated. The trusted authority 120 digitally signs the response+the timestamp. The communication device 101 then validates the record.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
generate a first hash of information, wherein the first hash of the information is used to validate if the information has changed and wherein the first hash of the information is generated locally;
send the first hash of the information to a trusted authority, wherein the trusted authority is a service that is managed by an external party;
detect a validation event associated with the information;
send a request for the first hash of the information to the trusted authority;
receive, from the trusted authority, the first hash of the information;
generate a second hash of the information, wherein the second hash of the information is generated locally; and
compare the received first hash of the information to the generated second hash of the information to determine if the received first hash of the information is the same as the second hash of the information, wherein the comparison is done locally.

2. The system of claim 1, wherein the information is a software application and/or a software component, wherein the validation event is determining whether to load the software application and/or the software component, and wherein the microprocessor readable and executable instructions further cause the microprocessor to:
in response the received first hash of the information being the same as the second hash of the information, loading the software application and/or component.

3. The system of claim 1, wherein the first hash comprises a plurality of hashes of a plurality of blocks in a blockchain.

4. The system of claim 3, wherein the blockchain is not part of a distributed ledger.

5. The system of claim 1, wherein the first hash comprises one of:
a forward first hash of the information and a first reverse hash of the information;
the first forward hash of the information using a first hashing algorithm and a second forward hash of the information using a second hashing algorithm; and
a first reverse hash of the information using the first hashing algorithm and a second reverse hash of the information using the second hashing algorithm.

6. The system of claim 1, wherein the information is an authentication credential, wherein the validation event is determining whether to authenticate a user using the authentication credential, and wherein the microprocessor readable and executable instructions further cause the microprocessor to:
in response the received first hash of the information not being the same as the second hash of the information, not authenticating the user.

7. The system of claim 1, wherein the first hash is a hash of an encrypted authentication credential.

8. The system of claim 1, wherein the first hash comprises a plurality of hashes of a plurality of authentication credentials.

9. The system of claim 8, wherein the first hash further comprises an overall hash of the plurality of authentication credentials.

10. A method comprising:
generating, by a microprocessor, a first hash of information, wherein the first hash of the information is used to validate if the information has changed and wherein the first hash of the information is generated locally;
sending, by the microprocessor, the first hash of the information to a trusted authority, wherein the trusted authority is a service that is managed by an external party;
detecting, by the microprocessor, a validation event associated with the information;
sending, by the microprocessor, a request for the first hash of the information to the trusted authority;
receiving, by the microprocessor, from the trusted authority, the first hash of the information;
generating, by the microprocessor, a second hash of the information, wherein the second hash of the information is generated locally; and
comparing, by the microprocessor, the received first hash of the information to the generated second hash of the information to determine if the received first hash of the information is the same as the second hash of the information, wherein the comparison is done locally.

11. The method of claim 10, wherein the information is a software application and/or a software component, wherein the validation event is determining whether to load the software application and/or the software component, and further comprising:
in response the received first hash of the information being the same as the second hash of the information, loading the software application and/or the software component.

12. The method of claim 10, wherein the first hash comprises a plurality of hashes of a plurality of blocks in a blockchain.

13. The method of claim 12, wherein the blockchain is not part of a distributed ledger.

14. The method of claim 10, wherein the first hash comprises one of:
a forward first hash of the information and a first reverse hash of the information;
the first forward hash of the information using a first hashing algorithm and a second forward hash of the information using a second hashing algorithm; and
a first reverse hash of the information using the first hashing algorithm and a second reverse hash of the information using the second hashing algorithm.

15. The method of claim 10, wherein the information is an authentication credential, wherein the validation event is determining whether to authenticate a user using the authentication credential, and further comprising:
in response the received first hash of the information not being the same as the second hash of the information, not authenticating the user.

16. The method of claim 10, wherein the first hash is a hash of an encrypted authentication credential.

17. The method of claim 10, wherein the first hash comprises a plurality of hashes of a plurality of authentication credentials.

18. The method of claim 17, wherein the first hash further comprises an overall hash of the plurality of authentication credentials.

19. A trusted authority comprising:
a microprocessor; and
a computer readable medium, coupled with the microprocessor and comprising microprocessor readable and executable instructions that, when executed by the microprocessor, cause the microprocessor to:
receive, from a communication device, a first hash of information;
store, the first hash of the information;
receive, from the communication device, a request to send the first hash of the information; and
send the first hash of the information to the communication device, wherein the communication device compares the first hash of the information to the sent first hash of the information.

20. The trusted authority of claim 19, wherein the first hash of the information is a hash of at least one of: a software application and/or software component, an authentication credential, an overall hash of a plurality of authentication credentials, an encrypted authentication credential, a blockchain, and a block of a blockchain.
